(19) United States
(12) Patent Application Publication
(10) Pub. No.: US 2006/0015402 A1
(43) Pub. Date: Jan. 19, 2006

(54) Using multiple PINs for redemption through multiple distribution channels

(76) Inventors: Phillip Craig Graves, Atlanta, GA (US); Phil M. Chakiris, Atlanta, GA (US)

Correspondence Address: HUNTON & WILLIAMS LLP, Riverfront Plaza, East Tower, 951 E. Byrd Street, Richmond, VA, 23219-4074, US

(21) Appl. No.: 11/062,249

(22) Filed: Feb. 18, 2005

Related U.S. Application Data
(63) Continuation-in-part of application No. 10/864,809, filed on Jun. 10, 2004.

(51) Int. Cl. G06Q 99/00

(52) U.S. Cl. 705/14

(57) ABSTRACT

In one exemplary embodiment, a system and method for enabling a customer to redeem a plurality of identifiers for at least one product associated therewith are provided. A database having stored therein the plurality of identifiers associated with the at least one product is established. The plurality of identifiers are collectively but not individually redeemable for the at least one product. A representation of each of the plurality of identifiers is distributed, each representation comprising information sufficient to identify only one of the plurality of identifiers. A plurality of redemption identifiers is received from a requestor. A request to redeem the plurality of redemption identifiers is received from the requester. A first authorization result is issued to the requestor in response to the request.

### RELATED APPLICATIONS

This application claims priority to U.S. application Ser. No. 10/864,809 entitled “System and method for distributing an identifier redeemable for a plurality of products,” filed on Jun. 10, 2004 under Attorney Docket Number 64243.000037, the disclosure of which is incorporated herein by reference in its entirety.

### FIELD OF THE INVENTION

This invention relates to distributing identifiers usable to access value. More particularly, the invention relates to distributing a plurality of identifiers that can be used to redeem value through a plurality of different distribution channels.

### BACKGROUND OF THE INVENTION

Identifiers such as personal identification numbers (PINs) can be used to access value and sensitive information stored in accounts associated with the specific PINs. Because a PIN is typically unique and known only to the individual accountholder, PINs can verify an accountholder's identity and thereby authorize accountholder access to account value. Typically PINs are long enough that it would be difficult or impractical for someone to guess them randomly. Provided the PIN is kept secret, a PIN owner may access account value and/or confidential information with little fear of theft. Additionally, a PIN can be memorized or carried with a PIN owner.

One advantage of using PINs is that a PIN owner may access account value from anywhere. Because PINs are usually associated with an automated redemption system, the PIN value or information can typically be accessed at any time. Because PINs can be provided at any account access point, such as a computer terminal, PINs dramatically increase the times and places that an accountholder can access the account. For instance, bank accountholders can provide their PIN and thereby access account information or pay bills via ATM machines and personal computers instead of physically traveling to a bank building during regular business hours.

Thus, PINs are an efficient means for merchants to distribute value to customers. I.e., merchants may distribute a PIN associated with a value to a customer rather than distributing the value itself. Customers can later use the PIN to redeem the value or good. Thus, PINs can effectively be used to shift the time of distribution to a later time at the convenience of the customer. For instance, a telecommunications service provider may distribute telecommunication service value by distributing a PIN associated with an amount of telecommunication value. For instance, a telecommunications card (phone card) and an associated PIN may be distributed to a customer at a point of sale. The card and PIN may be associated with a stored value account at a central processor, such as an account storing telecommunications service value stored by a telecommunications service provider. At a time and place of the customer's choosing, the customer may access the telecommunications provider's system and then provide the PIN to access the stored account value, such as minutes of telecommunications service. Upon verification of the PIN, the telecommunications provider may then provide telecommunications service to the customer.

Conventional PIN systems are limited in that a PIN is typically associated with a single account and a single value. For instance, a PIN may be used to access information or value for a specific account. Typically the value is of a single type, such as telecommunication minutes, dollars, or points. For instance, a phone card PIN is typically redeemed only for a phone minutes, and a bank PIN may only be used for withdrawing cash value from the account.

Another disadvantage with conventional PIN and password systems is that unauthorized individuals who obtain someone's PIN or password may access the value stored in that person's account. For instance, if a PIN is written somewhere, an unauthorized individual may discover the writing and use the PIN to add value to their own phone account.

Other limitations and disadvantages with conventional PIN systems exist.

### SUMMARY OF THE INVENTION

In one exemplary embodiment, a system and method for enabling a customer to redeem a plurality of identifiers for at least one product associated therewith are provided. A database having stored therein the plurality of identifiers associated with the at least one product is established. The plurality of identifiers are collectively but not individually redeemable for the at least one product. A representation of each of the plurality of identifiers is distributed, each representation comprising information sufficient to identify only one of the plurality of identifiers. A plurality of redemption identifiers is received from a requester. A request to redeem the plurality of redemption identifiers is received from the requestor. A first authorization result is issued to the requestor in response to the request.

In another embodiment, a system for enabling a customer to redeem a plurality of identifiers for at least one product associated therewith is provided. A database storage system stores therein the plurality of identifiers associated with the at least one product, the plurality of identifiers being collectively but not individually redeemable for the at least one product. A distribution module distributes a representation of each of the plurality of identifiers, each representation comprising information sufficient to identify only one of the plurality of identifiers. An input device receives from a requester a plurality of redemption identifiers and a request to redeem the plurality of redemption identifiers. An authorization module issues a first authorization result to the requestor in response to the request.

In another embodiment, a method of enabling a customer to redeem a plurality of identifiers for at least one product is provided. A database having stored therein the plurality of identifiers associated with the at least one product is established. The plurality of identifiers are collectively but not individually redeemable for the at least one product. The plurality of identifiers are redeemable upon receiving each of the plurality of identifiers in any successive order. A representation of each of the plurality of identifiers is distributed, each representation comprising information sufficient to identify only one of the plurality of identifiers. The act of distributing comprises providing a first identifier with a product sold to a customer at one time and distributing a second identifier through a different channel of distribution at a different time. A plurality of redemption identifiers is received from a requester. A request to redeem the plurality of redemption identifiers for the at least one product is received from the requester. The plurality of redemption identifiers is compared with the plurality of identifiers. Responsive to a determination that the plurality of redemption identifiers match the plurality of identifiers, redemption for the at least one product is authorized. A first authorization result is issued to the requestor. The at least one product is distributed to at least one of the requestor and a recipient designated by the requestor. The database is amended based on the distributing action.

Other embodiments could be considered.

### BRIEF DESCRIPTION OF THE DRAWINGS

FIG. 1 illustrates a system for distributing a product according to an embodiment of the invention.

FIG. 2 shows a system for distributing and activating an identifier according to an embodiment of the invention.

FIG. 3 shows an exemplary product comprising an identifier according to an embodiment of the invention.

FIG. 4 shows an exemplary card product comprising an identifier according to an embodiment of the invention.

FIG. 5 shows a method of distributing an identifier to a customer according to an embodiment of the invention.

### DETAILED DESCRIPTION OF THE EMBODIMENTS

The invention provides systems and methods that enable customers to purchase one or more of a set of products through the use of one or more identifiers such as PINs, passwords, biomedical identifiers, access codes, and/or a combination of PINs, passwords, biomedical identifiers, and access codes. As discussed in more detail below, these methods may include providing one or more identifiers such as PINs to a customer in any of various ways. The identifiers may be operative to redeem one or more of a set of products that have been associated with the identifier(s) in a database maintained by a central processor. The customer may access the central processor or a particular product provider and request that the identifier be redeemed for one of the set of products. A redemption request may be forwarded to the central processor or provider either by the customer himself or by a retailer or other intermediary. If approved by the central processor, a redemption authorization is provided and the product may be provided to the customer. In some embodiments, the customer may use the same PIN more than once to obtain additional products. In some embodiments, the customer may use a plurality of PINs to redeem a single product or a plurality of products, and each of those PINs may be usable once or more than once. The redemption request may be communicated over the same or different communication channels for each product redemption. A plurality of different providers may provide the products through a plurality of different distribution channels.

It should be understood that more than one identifier may be required to redeem any single product or plurality of products. For instance, a customer may collect a number of identifiers in order to make a first (or second, etc.) redemption. Thus, it should be appreciated that the use of the term “identifier” herein may also refer to a plurality of identifiers.

The identifiers may be associated (e.g., in the database) with one or more predetermined goods or services (collectively, “products”), one or more good or service providers (collectively, “product providers”), one or more communication networks, one or more redemption channels, one or more accounts, and one or more points of redemption.

Identifiers may be distributed in a variety of ways. For instance, identifiers such as PINs may be printed on cards that may be sold or otherwise distributed to customers at merchant stores. An identifier may also be printed on a receipt provided to a customer, e.g., upon purchase of a particular product. An identifier may be packaged with a product; for instance, a customer may select or purchase one product, and the identifier may attached to the product, enclosed with the product or its packaging, printed on the product itself, or otherwise coupled to the product or its packaging.

In a particular embodiment, one or more identifiers may be distributed along with a separate (or coupled) product. In some embodiments, the identifiers may be distributed as an added value to provide extra incentive to purchase the product. For example, prepackaged merchandise purchased from a retailer may include indicia sealed inside the package that includes one or more unique identifiers that may be redeemed for other products related (or unrelated) to the purchased merchandise.

By way of example, a customer or other end-user (“customer”) may receive a product that contains an identifier such as a PIN, wherein the identifier is pre-associated with a set of products for which it may be redeemed. The customer may then purchase (or otherwise receive) a product or other merchandise that contains additional identifiers such as PINs. For example, each additional product may contain one or more PIN, and/or additional PINs may be available through other means (such as by receiving them on the back of a coupon or accessing them over the Internet). The customer may then contact a central processor, e.g., directly (such as over the Internet) or with the assistance of an intermediary merchant, to request to redeem one or more identifiers for a first product. Typically, the customer will provide the one or more identifiers and may also identify the product desired (e.g., by selecting the product from among multiple possible product redemptions).

The central processor may then determine whether the redemption request is valid. For instance, the central processor may access a database of identifiers and verify that the one or more identifiers are valid and that they have not yet been redeemed, e.g., for the requested product. The central processor may pass a redemption authorization response to the redemption requester (i.e., the customer or an intermediary merchant) in the form of a confirmation that the first product will be redeemed. The central processor may then initiate a process to provide the first product to the customer. For instance, the central processor may request a first provider to provide the first product to the customer.

Alternatively, if the redemption request is made through a retailer, the authorization may instruct or authorize the retailer to provide the product to the customer. The central processor may then amend the database to reflect that the first product was redeemed for the provided identifiers. Depending on the embodiment, the process may be repeated when the customer subsequently requests to redeem the same one or more identifiers (or another associated set of one or more identifiers) for a second product (e.g., a second one of the first product).

Thus, in some embodiments, a plurality of PINs may be redeemed for a single product. In other embodiments, a plurality of PINs may be redeemed for a single PIN. For instance, three PINs may be redeemed for a single PIN that is associated with an account having a value that is greater (e.g., three times greater) than the value of the original three PINs. A certain number of these enhanced value PINs may be redeemed for a PIN that has an even greater value.

It will be understood that the identifiers provided in the methods of the invention may be used to access any of a variety of products. Examples of products and services that may be accommodated, redeemed, or accessed by identifiers include: long distance telephone communication, wireless communication, paging and internet-enabled communication services (such as wireless web access), emergency road service, legal service, accounting service, tax service, property cleaning and/or maintenance service, clothe cleaning service, transportation service, call service (e.g., wake-up call service), travel service, delivery service, online (or off-line) dating service, electrical and/or gas service, water service, sewage service, internet access, and film processing (including digital film processing). Other examples of prepaid products and services that may be accessed by an identifier include: gift accounts, prepaid gas accounts, prepaid grocery accounts, prepaid entertainment accounts, prepaid movie accounts, downloadable ring tone accounts, downloadable game accounts, downloadable image accounts, downloadable video or movie accounts, downloadable music accounts (e.g., for music files that use MP3, MP4, WMV, WAV, or other formats), any other downloadable software account, customer rewards accounts, bridge and/or road toll accounts, and any other type of value that may be accessed via an identifier.

The products associated with an identifier may also include merchandise. For instance, the product may be a video game, a video game console, a transaction card (such as a credit card, debit card, or stored value card), an audio-visual product (such as a DVD, CD, downloadable music card), a concert ticket, or a gift certificate. Associated products may also include software or other downloadable content.

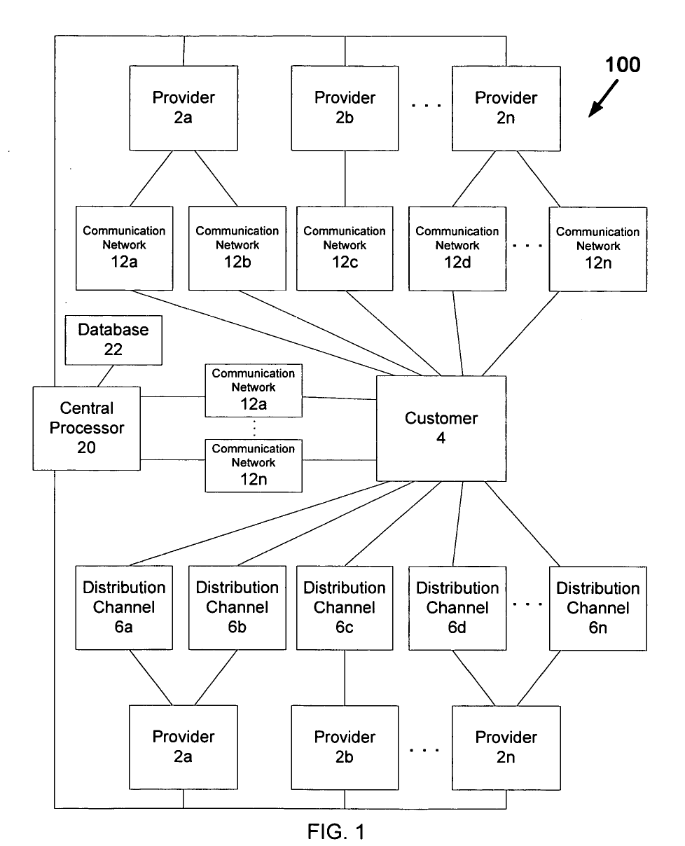

FIG. 1 illustrates a system 100 for distributing a product according to an embodiment of the invention. The system 100 comprises one or more providers 2a-2n, each of which may be selectively in communication with a customer 4 and/or a central processor 20 via one or more communication networks 12a-12n. The central processor 20 may be coupled to a database 22 that stores one or more identifiers (e.g., unique identifiers) as well as information associated with each identifier, such as information relating to products that may be redeemed by the identifier (or the redeemable products themselves, such as downloadable content). Each provider 2 may be configured to provide a product to the customer 4 via one or more distribution channels 6a-6n.

A customer 4 may pass a request for one or more products to a central processor 20 either directly (e.g., through a VRU) or through an intermediary (e.g., a merchant). Communications (e.g., requests and responses) may be passed between and among the different entities via one or more communication networks 12a-12n. The communication networks 12a-12n may comprise any communication device or network for communicating between one party (e.g., a customer) and another (e.g., a merchant, provider, or central processor). Technologies used to provide such communication might include a network (such as a telephone or computer network), a dedicated circuit, an IP based connection, the Internet, Intranet, Extranet, LAN, WAN, VPN, an Ethernet, or any client server system that provides communication, for example. Such communications technologies may use any suitable protocol such as TCP/IP, UDP, OSI, SNA, X.25, ISO 85/83, XML or SOAP, for example. The communication network may pass data between and among one or more merchant terminals 10a-10n and a central processor 20.

Alternately, the customer may pass the request for one or more products directly to one or more providers 2a-2n via one or more communications networks 12a-12n (e.g., a network using http or https).

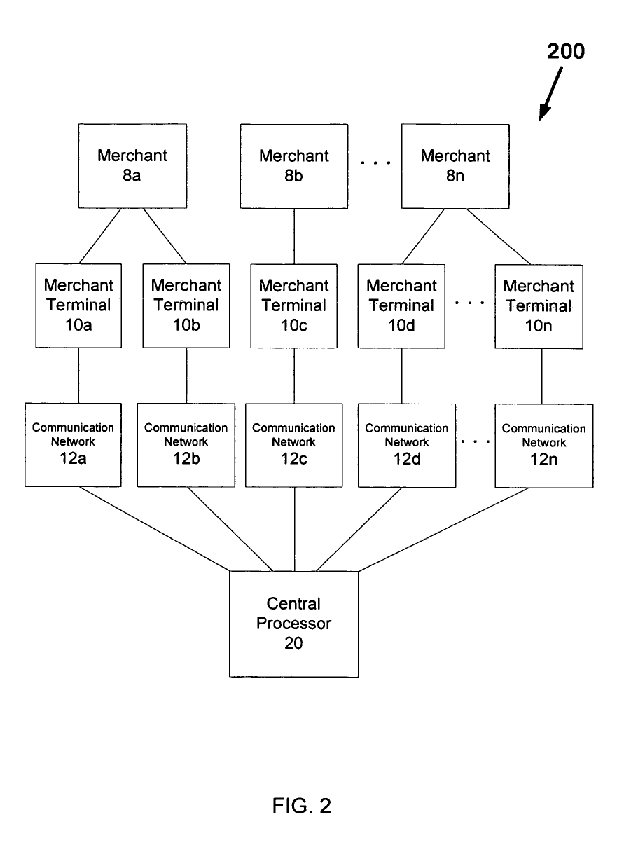

FIG. 2 shows a system 200 for distributing and activating one or more identifiers according to an embodiment of the invention. A merchant 8a-8n may distribute one or more identifiers and/or an associated product to a customer, e.g., in a merchant store. For instance, a customer may purchase the product(s) and/or identifier(s) at a merchant terminal 10a-10n. Each identifier may then be used to redeem a value such as a product (e.g., one or more of a set of predetermined products, which may be associated with the product purchased at the merchant terminal 10).

For instance, the customer may purchase a concert ticket for a famous musician, and one or more identifiers may be printed on a receipt or on the ticket itself. After the concert, a single PIN (or plurality of PINs) may be used to obtain a poster of the musician and to download songs performed by the musician at the concert. In another example, the customer may purchase a CD featuring the same musician, and one or more cards with one or more identifiers printed on them may be disposed within the CD package. The identifier(s) may then be redeemed, for example, for additional songs downloaded from the Internet. In other embodiments, the downloaded songs, poster, and CD may all be redeemed from a single PIN (or plurality of PINs). In still other embodiments, one or more of these items may be redeemed from a collection PINs. For instance, a customer may collect PINs acquired through the purchase of other items, such as other CDs from the same artist or stickers on the back of boxes of french fries from a specific fast food merchant.

In some instances, one or more identifiers may require activation before they may be redeemed or used by a customer. For example, a customer may receive one or more PINs that are redeemable for one of a set of prepaid services. The PINs may be activated at the time they are received by the customer. For instance, when the PINs are received with one or more associated products purchased at one or more merchant terminals 10, the merchant terminals 10 may pass an activation message to a central processor 20 via a communication network 12. In some embodiments, each PIN may be acquired separately with separate products. The central processor 20 may activate an identifier by amending a database 20 storing identifier information, such as activation information and information about the set of products associated with the identifier (e.g., redemption information). The central processor 20 may then pass an activation confirmation message back to the corresponding merchant terminal 10. The merchant terminal 10 may then pass an activation confirmation to the customer 4.

In some embodiments, the database 20 may store a set of identifiers associated with one or more value redemptions (e.g., products for which one or more identifiers may be redeemed). For instance, a subset of identifiers (e.g., three unique identifiers) may be redeemable for one set of products, and another subset (e.g., a subset comprising all, some, or none of the same identifiers as those of the first subset) may be redeemable for the same or a different set of products. For instance, a customer may redeem any three of a set of ten identifiers for a one particular product (or set of products), and the customer may redeem any five of the identifiers for a different product (or set of products), e.g., a product of greater value than the first product (or product set). In some embodiments, the five identifiers must comprise one or more specific identifiers of the ten identifiers, while any three identifiers may be redeemable for the first product.

In some embodiments, an identifier that is redeemed for any product may not be used toward any further redemptions. In other embodiments, an identifier may used in a product redemption more than once. For instance, in some embodiments, any set of three identifiers (from among a set of ten unique identifiers) may be redeemable for one or more items, but a given combination of three identifiers may be redeemed only once. For instance, in this embodiment, identifiers 1, 2, and 3 may be collectively redeemed only once, and identifiers 1, 2, and 4 may be collectively redeemed only once.

In some embodiments, a customer may make a particular redemption a limited number of times. For instance, a first customer may collectively redeem identifiers 1, 2, and 3 for a given product (e.g., but may do so only once), and another customer may collectively redeem the same identifiers 1, 2, and 3 for the same product.

The central processor 20 may be any server, computer, computer system, hub, database, data processor, credit network, or other computer system, or any other processor. The central processor 20 may be configured to process data received from merchants 8 and merchant terminals 10. The central processor may also be adapted for direct communication with a customer over a telephone network or via a data processing network such as the Internet.

A merchant terminal 10 may comprise any terminal at a merchant 8 used to process customer transactions. A merchant terminal 10 may comprise a cash register, PC terminal, barcode reader, magnetic stripe reader, credit card terminals, an ATM, or other terminal used for communicating information with customers. A merchant terminal 10 may be inside a merchant 8 store or outside a merchant 8 store. For instance, a customer may purchase a product, and the purchase transaction may be processed at a merchant terminal 10.

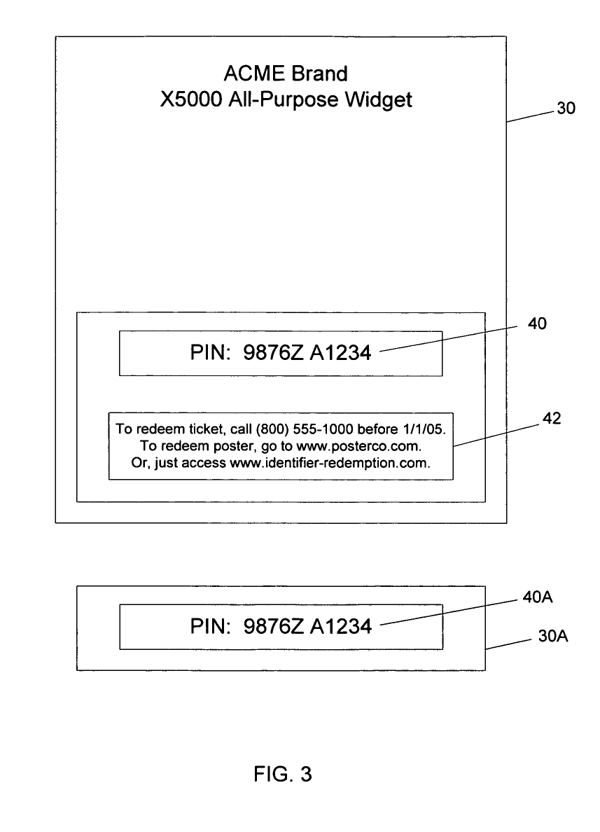

FIG. 3 shows an exemplary product comprising one or more identifiers according to an embodiment of the invention. As shown in FIG. 3, a product 30 may comprise an indicia 40. Here, the product is an “ACME Brand X5000 All-Purpose Widget,” although it will be appreciated that the product may be any type of product, service, or value.

The product 30 may be any other good or service that may be associated with an indicia 40 of an identifier, such as a CD, DVD, ticket, phone card, other stored value card, other financial product, or other good or service. In some embodiments, there may be no product; rather, the indicia 40 may be provided to a customer separately from any product. Alternately, some identifiers may be acquired with a product, and other identifiers may be acquired without an associated product. The identifiers may be collectively (or individually) redeemable for one or more goods or services. In some embodiments, the “product” 30 may be an indicia of service. For instance, the indicia may comprise a receipt, such as a receipt for providing a product or service, or the indicia may comprise another communication related to a product or service. The product may also be an electronic product, such as a file download (e.g., music file download or video game), web page access, email, or other electronic file or program.

The indicia 40 (also called a representation of an identifier) may be any paper, writing, printing, email, audio file, video file, or other audio-visual means of communicating an identifier, or it may comprise information not disclosed visibly. For instance, the indicia may comprise an RFID device capable of communicating the identifier to an authorized receiver device. The identifier may be any number or code, such as “9876Z A1234,” as shown in FIG. 3. The indicia 40 may be included with the product 30, or it may be provided separately. In some embodiments, the indicia may be on or otherwise part of the product. For instance, a DVD movie product may have an identifier encoded in it such that playing the DVD will cause the television to display the identifier, e.g., as part of the “extra features” section of the DVD menu.

FIG. 3 shows an indicia 40 printed on the product and another indicia 40A provided on a receipt or other communication 30A separate from the product 30. Thus, the identifier may be provided on more than one indicia 30. However, in some embodiments a single identifier may be provided only once. For instance, the identifier may be provided as shown in item 40 or as shown in item 40A, but not both.

The indicia 40 may have a physical embodiment, such as a sticker on a label of a product or a product container, or a printout on a receipt 30A. The indicia 40 may also be electronic. For instance, the indicia 40 may be an email, short message service (SMS) message (e.g., a text message), voicemail message, or other communication that indicates the identifier. In some embodiments, the indicia may be sent electronically to the purchaser of the product (or to a recipient designated by the purchaser, or to another person). For instance, the email may be an indicia that lists the identifier (or a plurality of identifiers) in the text of the email. The indicia 40 may also be any other means of communicating the identifier to an end user, such a sound file comprising the sound of a voice speaking the characters (e.g., numbers) of one or more identifiers and/or instructions for redeeming the one or more identifiers.

The product 30 and/or indicia 40 may comprise identifier redemption instructions 42. The instructions 42 may indicate how an identifier may be redeemed for one or more associated products. For instance, the instructions 42 may provide provider information, redemption expiration dates, and any other data associated with the product 30, identifier, and/or other product redemption information. The instructions 42 may be provided with the identifier indicia 40 or another indicia. For security purposes, the instructions 42 may be provided to the user separately from the indicia 40. For instance, the indicia 40 may be provided with the product, while instructions 42 may be provided via mail (or email) after registering the product.

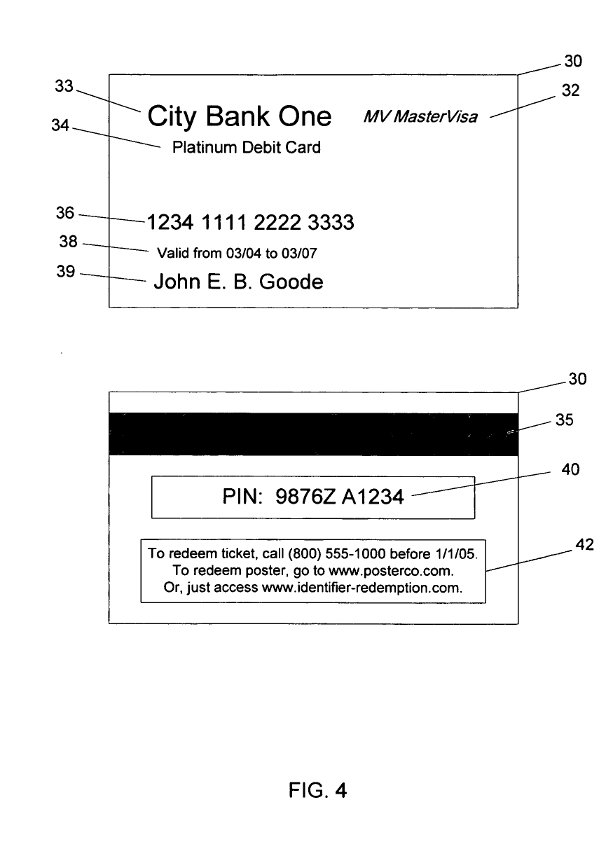

FIG. 4 shows an exemplary card product 30 and an indicia 40 of an identifier according to an embodiment of the invention. FIG. 4 shows the front view and rear view of the product 30. Here, the product is a transaction card 30, such as a credit card, debit card, phone card, or other stored value card. The card 30 may comprise an issuer indicia 33, a credit network indicia 32, a card title 34, an account number or card number 36, validity dates and/or expiration data 38, a cardholder name 40, a magnetic stripe 35, redemption instructions 42, and any other indicia of information associated with the account.

In the embodiment shown in FIG. 4, the indicia 40 is a number printed on a sticker (or other adhesive) attached to the back of the card. The identifier may or may not be coupled to a product (e.g., via an adhesive). In another embodiment, there may be no sticker indicia 40, and the card number 36 may instead be the indicia of the identifier.

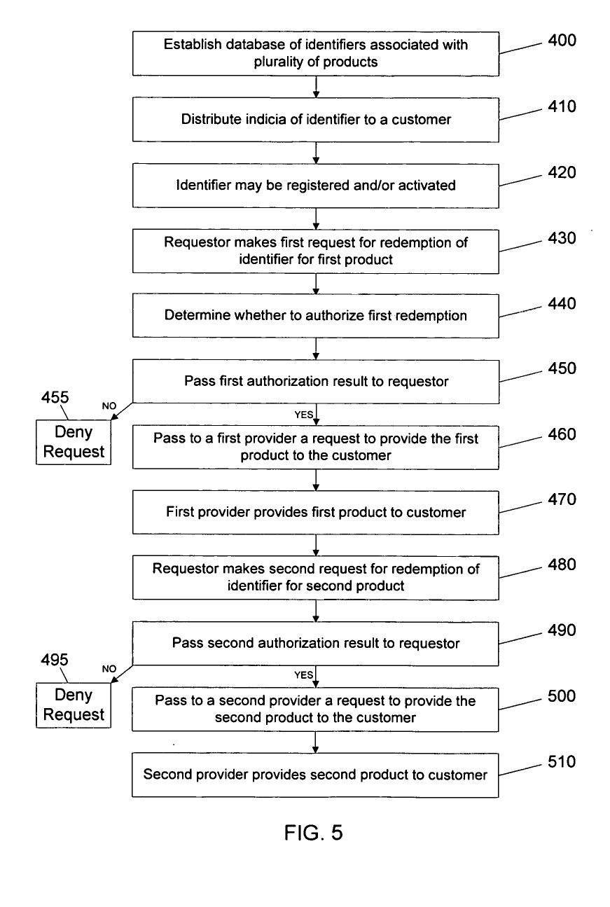

FIG. 5 shows a method of distributing an identifier to a customer according to an embodiment of the invention.

In block 400, a database of identifiers may be established, wherein one or more identifiers may be associated with one or more products. For instance, multiple identifiers may be associated with a single product or a set of products, and a set of identifier groups may be associated with a set of products. In some embodiments, each identifier (or set of identifiers) may be associated (e.g., in the database) with a specific set of products, such as products that may be redeemed by providing the identifier. The database may store any information related to the identifiers or associated products, such as redemption or product distribution information. This information may be stored for each identifier in a separate database entry. (In some embodiments, the information for a plurality of identifiers associated with a single product may be stored in separate entries.) For instance, each identifier may be associated with a product that is distributed with (e.g., attached to) an indicia of the identifier. Each identifier may also be associated with one or more providers, such as the providers who may provide the products associated with the identifier. Each identifier and/or each product associated with the identifier may also be associated with validity data, such as dates of validity (e.g., expiration dates). Each identifier and/or product associated therewith may be associated with a distribution channel for distributing the product to a customer and/or a communication network for passing information between a customer and a central processor (or provider) related to the product or identifier, such as a request for redemption of the product.

As noted earlier, a plurality of identifiers (or a single identifier) may be identified with a specific product or group of products.

The database may also store redemption data for each product associated with a specific identifier. The database may be amended to indicate that a specific identifier has (or has not) been used to redeem a particular product.

For instance, a plurality of identifiers may be stored in a database. Each identifier may be associated with, e.g., a concert ticket, a poster, food item, coupon, downloadable music files, gift certificates, stored value cards, etc. Each of the concert tickets and other items (and the identifier or set of identifiers) may be associated with one or more providers. The concert ticket may be associated with TicketCo; the poster may be associated with PosterCo and MemorabiliaCo, and the music files may be associated with iMusicCo. The downloadable music files may further be associated with a particular distribution channel, such as the Internet. The ticket may be associated with a communication network, such as a phone network (and/or a specific 800 number that can be used by a customer to redeem the identifier for a ticket).

In block 410, indicia of one or more identifiers may be distributed to a customer. As previously discussed, the indicia may be distributed in a variety of ways. The indicia may be distributed on or with a product that may be purchased by a customer. For instance, the indicia may be provided inside or on a DVD or other product (such as a food product), or the identifier may be on a sticker attached to the back of the DVD or other product. The identifier may also be provided on a receipt when a customer purchases a product. The indicia may also be a text message sent to the customer's mobile phone or portable gaming device such as a SonyTM PSP. Multiple indicias may be distributed to the customer through a variety of means. The customer may collect a plurality of related identifiers.

The identifier may be distributed in an active state. That is, it may be distributed so that it is immediately usable by whoever obtains it, regardless of how it was obtained. Alternatively, the identifier may be provided in an inactive state, in which case it must be activated before it can be used.

In block 420, the identifier(s) may be registered and/or activated. This action may occur when the customer receives the identifier. For instance, the customer may purchase or otherwise obtain a stored value card (or other transaction card) from a merchant. The stored value card account number may be the identifier (or the identifier may be otherwise coupled to or associated with the card). During the purchase transaction, card information may be input at a merchant terminal. For instance, a magnetic stripe of the card may be swiped. The identifier may be activated when the card is swiped at a merchant terminal. The activation of cards at merchant terminals is well known in the art. For instance, during this process, the merchant terminal may pass card information (e.g., the identifier) to a central processor coupled to the database, and the central processor may then amend the database to reflect that the identifier has been activated. Activation may be contingent upon confirmation signals between the merchant terminal and central processor. For example, the central processor may not activate the identifier until it verifies that the product (the transaction card) has been validly purchased (e.g., that the customer's purchase funds have cleared).

A customer may need to collect a plurality of identifiers before activating or redeeming any of them. For instance, five identifiers may be required before any of them may be activated. Also, a number of identifiers (such as seven) may be required for redeeming a particular product. For instance, the number of products (e.g., number of downloadable songs) or quality of products (e.g., a cheap toaster compared to an expensive car) to be redeemed may depend on the number or type of identifiers collected by the customer. For instance, a customer may need to collect twenty premium PINs in order to redeem them for a special product or 10,000 points worth of products and services selected from a list. In some embodiments, a customer may collect only five premium PINs (or another number of regular PINs) to redeem a lesser priced product or service (or group of products and services).

In some embodiments, the identifier is not activated at the time of purchase of an associated product, but is instead activated upon separate request or upon first use by the customer. This may be advantageous as a marketing tool because it may require a return visit by the customer to the outlet where the associated product was purchased. In such embodiments, activation may carried out in much the same manner as described above.

In other embodiments, the customer may register or activate an identifier without ever knowing the identifier. For instance, a customer may purchase a product comprising a computer-readable medium, such as a CD or DVD, that stores an identifier. The customer's computer may follow program instructions encoded on the CD or DVD and automatically provide the identifier at a redemption website. The identifier encoded on the CD or DVD may be copy-protected, such that only the original CD or DVD may be used in acquiring the PIN. Each original copy of the CD or DVD may have the same identifier (due to the copy protection), or each may have a different identifier.

In block 430, a request to redeem the identifier(s) for a first product (or group of first products) is passed to a central processor. This request may be submitted by a customer directly or may be submitted through a merchant. The request may comprise the identifier(s). For instance, the requestor (i.e., the customer or merchant) may access a central processor or provider, e.g., via phone or Internet. The requestor may follow instructions for redemption (e.g., if provided, e.g., on the indicia). For instance, the requester may access a central processor's website or phone number according to the instructions and then enter the identifier and personal information of the customer, such as name, address, source of identifier(s), etc. Alternatively, the customer may present the identifier to a merchant who forwards a redemption request to the central processor or provider. In a particular embodiment, the merchant may be a provider of the product for which the customer wishes to redeem the identifier(s).

The request may indicate a selection of a particular product. For instance, the identifier(s) may be redeemable for a plurality of different products, and the customer may only wish to obtain one of the products in a single redemption request. Thus, the requestor may select from among a plurality of products (or product types) for redemption. For example, if an identifier(s) is redeemable for a concert ticket as well as a number of downloadable songs (e.g., four songs), the customer may choose to redeem only the concert ticket.

Similarly, a single product redemption type may require (or allow) customer choice. For example, if the customer chooses to redeem the identifier for three of the four downloadable songs, the customer may select three songs for download from among a plurality of songs. For some kinds of products it may be desirable to permit the customer to obtain more than one of a particular product as an alternative to obtaining the same number of different products.

It should be noted that while the customer may select a single product for redemption in this block, the customer may redeem any number of products simultaneously according to some embodiments.

The central processor may prompt the requestor for the identifier (or collection of identifiers). For instance, the requester may access a web page associated with the central processor, and an input field may request the identifier(s). The requestor may then type (or otherwise input) the identifier(s) and submit the information to the central processor, e.g., by pressing “return.”

In some embodiments, the identifier indicia(s) may be provided in the form of a separate card(s) having a magnetic strip or other machine readable storage medium having the identifier stored therein. In these embodiments, the redemption request may involve reading the identifier using a scanner or magnetic strip reader. A request, including the machine-read identifier may then be transmitted to the central processor.

In some embodiments, one customer or multiple customers may redeem a plurality of identifiers simultaneously. For instance a single customer may redeem several PINs for a single product. In other embodiments, multiple customers may collectively redeem a plurality of PINs for a single product or service (or multiple products or services). For instance, a team of people playing an online video game (e.g., on a PC, a MicrosoftTM Xbox, or a Sony PSP) may collectively provide PINs received with their copy of the game (or from another product such as a fast food hamburger) to redeem special services such as bonus points, additional game options, or other benefits.

It should be noted that in some embodiments, the acts of activating the identifier(s) and the act of requesting to redeem the identifiers may be one and the same.

In some embodiments, the request to redeem may not identify the product (or product group) to be redeemed. For instance, a customer may request to redeem a plurality of identifiers for whatever may be redeemed, as determined by the central processor. The central processor may determine one or more products that may be redeemed for the received identifiers and then authorize fulfillment of the request. The central processor may communicate redemption information to the requester, such as by identifying what may be redeemed for the identifiers in question. The central processor may also indicate one or more products that may be redeemed using one or more additional identifiers. For instance, the use of an additional identifier (or the use of one or more identifiers of a different type) may be used to redeem a greater prize or other product (or service).

In some embodiments, the product to be redeemed for a given set of identifiers may be random (e.g., randomly selected from a set of products for which the identifiers may be redeemed). It should be noted that in some embodiments, the products that may be redeemed for given identifiers at one time may be different than what may be redeemed for the same identifiers at a later time.

In block 440, the central processor (or product provider) may determine whether to authorize redemption of the first product(s). For instance, the central processor (or provider) may access the database to determine any of (i) whether the identifier(s) is valid; (ii) whether the identifier(s) is redeemable for (and/or associated with) the requested product; (iii) whether the redemption request is timely (e.g., whether the requested redemption has expired); and (iv) whether the identifier(s) has already been redeemed for the requested product. Based on one or more of these determinations (or other determinations related to the identifier and/or product), the central processor may determine to authorize or not authorize redemption of the product. For instance, the central processor may decide to authorize the product if it determines that the identifier is valid and redeemable for the requested product, the request is timely, and/or the identifier has not yet been redeemed for the requested product.

It will be understood that a wide variety of criteria may be used to determine authorization of a redemption request. These may include, for example, limitations on the number of particular products that may be obtained using a particular identifier, the total number of uses of an identifier or a total value of products obtained using the identifier.

In some embodiments, the identifier(s) itself can be used to redeem products directly. For instance, the identifier may be (among other things) a valid PIN that may be used to access telecommunications service from a provider. The PIN may be activated in block 420, or it may be pre-activated. To redeem the telecommunications service (or a portion thereof), the customer may simply access the telecommunications provider and use the telecommunications service. The use of PINs to access telecommunications service is well known in the art.

In block 450, the central processor (or provider) may pass an authorization result to the requestor. If the central processor determines that the request should be granted, then the authorization result may be positive, i.e., the result may indicate that the request is being processed or that the product will be delivered, or some other indication that the customer will (or should) receive the product.

If the central processor determines that the request should not be granted, then the authorization result may be negative. For instance, if there is any problem with the redemption request and/or the identifier or requested good, the authorization result may indicate that the request has been denied. For instance, the request may be denied if any of the following are determined in block 440: (i) the identifier is not valid; (ii) the identifier is valid but not redeemable for the requested product; (iii) the request is not timely (e.g., not during a proper time of redemption, or expired); or (iv) the identifier has already been redeemed for the requested product or product type. Other invalidity criteria can be considered.

Block 455. If the central processor (or provider) determines not to authorize redemption of the first product, then the process may stop in block 455.

Block 460. If the central processor determines to authorize redemption of the first product (or set of products), then a request to provide the first product to the customer may be passed to the requestor and/or a first provider in block 460.

It should be noted that this block 460 may occur if a provider separate from the central processor is responsible for redemption of the first product. If the central processor can provide the product, then it is not necessary to pass a redemption request to a first provider. Rather, the central processor may simply redeem the first product directly. If the requestor is also the provider of the product requested, blocks 450 and 460 may be combined.

In block 470, a first provider (or central processor) may provide the first product(s) to the customer. Any method of distributing a product is contemplated herein. For instance, there may be a plurality of different distribution channels. Downloadable content may be delivered electronically via email or download. A poster or other physical product may be mailed or otherwise physically delivered to the customer, e.g., to the customer's mailing address. A coupon, gift certificate, and ticket may be mailed, or they may be delivered electronically (and printed). Telecommunications service may be obtained by accessing a telecommunications provider. However, a PIN that may be used to access the telecommunications service may be provided in this block through other distribution means.

It should be noted that the first provider may provide the first product to the customer via the central processor. For instance, the central processor may pass a request for redemption to the first provider in block 460, and the first provider may provide the product to the central processor, which may then provide the product to the customer.

For instance, if the central processor approves a customer's request for downloadable content in block 440, then the central processor may obtain the requested content from the provider and then enable the customer to download it from the central processor's website. For some products, like PINs used to access telecommunications service, the central processor may obtain the PINs earlier in the process, such as at the time the database is established in block 400 (or sometime thereafter).

For some products, the central processor and/or provider may redeem the product when they provide the customer with adequate instructions for obtaining the product. For instance, a banana split dessert may be redeemed when a provider (or central processor) provides the customer with a code that can be used to obtain a banana split at a particular dessert merchant on a specific day.

In block 480, the customer may make a request for redemption of the identifier(s) (or another set of identifiers) for a second product. This block is similar to block 430 for the first product.

In block 490, a central processor (or provider) may determine whether to authorize the second redemption. This block is similar to block 440 for the first redemption.

Block 495. If the central processor (or provider) determines not to authorize redemption of the second product, then the process may stop in block 495. This block may proceed in a manner similar to block 455 for the first product.

In block 500, a request to provide the second product to the customer may be passed to a second provider. This block is similar to block 460 for the first provider. It should be noted that the second provider may be identical to the first provider, or the second provider may be different from the first provider.

In block 510, the second provider may provide the second product to the customer. This block is similar to block 470 for the first provider.

It should be noted that blocks 430-460 (or blocks 480-510) may be repeated for a plurality of redemption requests. For instance, the process may repeat and products may be redeemed until all of the products associated with the identifier(s) (e.g., the entire set of products redeemable by the identifier(s)) are redeemed. For each product redemption, the database may be amended and/or updated to reflect that the specific product was redeemed so that it cannot be redeemed again. For instance, after a concert ticket is redeemed, the database may be amended to indicate that the concert ticket was redeemed for that identifier. If the customer tries to redeem the identifier for another concert ticket, the central processor may deny the request by determining that the request was already granted, as described in block 450. For products that may be redeemed in multiple iterations, the database may be amended to indicate the number or amount of remaining products of that type. For instance, if one product to be redeemed is 60 minutes of long distance telecommunications service, then the customer may redeem the 60 minutes over the course of several uses. For each use, the database may be amended to indicate the remaining value.

It will also be understood that in some embodiments, the authorization criteria for a particular identifier (or set of identifiers) may not allow for multiple redemptions of the same identifier (or set of identifiers), in which case the second request may always be denied.

The embodiments of the present inventions are not to be limited in scope by the specific embodiments described herein. Indeed, numerous variations, changes, substitutions and equivalents will be apparent to those skilled in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, it is intended that all subject matter described herein and shown in the accompanying drawings be regarded as illustrative only and not in a limiting sense and that the scope of the invention be solely determined by the appended claims. Also, the claims set forth below should be construed in view of the full breadth and spirit of the embodiments of the present inventions as disclosed herein.

What is claimed is:

1. A computer-implemented method of enabling a customer to redeem a plurality of identifiers for at least one product associated therewith, the method comprising:
establishing a database having stored therein the plurality of identifiers associated with the at least one product, the plurality of identifiers being collectively but not individually redeemable for the at least one product;
distributing a representation of each of the plurality of identifiers, each representation comprising information sufficient to identify only one of the plurality of identifiers;
receiving a plurality of redemption identifiers from a requestor;
receiving from the requestor a request to redeem the plurality of redemption identifiers; and
issuing a first authorization result to the requester in response to the request.

2. The method of claim 1, further comprising:
comparing the plurality of redemption identifiers with the plurality of identifiers; and
responsive to a determination that the plurality of redemption identifiers match the plurality of identifiers, authorizing redemption for the at least one product.

3. The method of claim 2, further comprising:
distributing the at least one product to a recipient designated by the requestor.

4. The method of claim 1, wherein the act of distributing a representation of each of the plurality of identifiers comprises distributing a first identifier through one channel of distribution at one time and distributing a second identifier through a different channel of distribution at a different time.

5. The method of claim 1, wherein the at least one product comprises a plurality of products and wherein the request includes a selection of one product from among the plurality of products.

6. The method of claim 1, wherein the at least one product comprises a plurality of products, each redeemable from a different provider.

7. The method of claim 1, further comprising:
authorizing redemption for at least one of the at least one product; and
passing to a provider a request to provide the at least one of the at least one product to a recipient.

8. The method of claim 1, further comprising:
redeeming the plurality of identifiers for the at least one product; and
amending the database based on the redeeming action.

9. The method of claim 1, wherein the act of distributing a representation comprises including an indicia of at least one of the plurality of identifiers with a product to be sold to a customer.

10. The method of claim 1, further comprising:
determining whether the plurality of redemption identifiers are redeemable for the at least one product.

11. The method of claim 1, wherein the at least one product comprises downloadable content.

12. The method of claim 1, wherein the representation comprises a receipt for a purchase of a product or service, the receipt including indicia of the identifier.

13. The method of claim 1, wherein the plurality of identifiers are comprised in a set of unique identifiers associated in the database with the at least one product, the at least one product comprising a first product, and wherein a second plurality of identifiers comprised in the set of unique identifiers are also collectively redeemable for the first product.

14. The method of claim 1, wherein the database associates a set of unique identifiers comprising the plurality of identifiers with a set of products comprising at least one first product and at least one second product, wherein a first subset of the set of unique identifiers comprises the plurality of identifiers and is collectively redeemable for the at least one product, and a second subset of the set of unique identifiers is collectively redeemable for at least one second product.

15. The method of claim 1, wherein the plurality of identifiers are received with the request in a single communication.

16. The method of claim 1, further comprising:
receiving personal information of the requestor.

17. The method of claim 1, wherein the plurality of identifiers are received from the requestor.

18. The method of claim 17, wherein each identifier is a unique identifier, and wherein more than one different requestor may redeem the plurality of identifiers for the at least one product, the method further comprising:
receiving a set of redeemable identifiers from a second requestor;
receiving a request from the second requestor to redeem the set of redeemable identifiers for the at least one product; and
issuing a first authorization result to the second requestor.

19. The method of claim 1, wherein the at least one first product comprises a plurality of products, further comprising:
distributing the plurality of products through a plurality of distribution channels, respectively.

20. The method of claim 1, wherein the request comprises the plurality of identifiers.

21. The method of claim 1, wherein the plurality of identifiers may be collectively redeemed by receiving the identifiers in any successive order.

22. The method of claim 1, wherein each identifier is distributed to more than one entity.

23. The method of claim 1, wherein the plurality of identifiers are alternately redeemable for at least one second product different from the at least one product.

24. The method of claim 1, wherein the request is a request to redeem the plurality of redemption identifiers for one or more of the at least one product.

25. The method of claim 1, further comprising:
identifying one or more redemption products for which the plurality of redemption identifiers may be redeemed based on information stored in the database.

26. The method of claim 25, further comprising:
receiving a selection from the requester of at least one of the one or more redemption products; and
passing a request to provide the selected at least one redemption product to a recipient.

27. A system for enabling a customer to redeem a plurality of identifiers for at least one product associated therewith, the system comprising: a database storage system configured to store the plurality of identifiers associated with the at least one product, the plurality of identifiers being collectively but not individually redeemable for the at least one product;
a distribution module configured to distribute a representation of each of the plurality of identifiers, each representation comprising information sufficient to identify only one of the plurality of identifiers;
an input device configured to receive from a requester a plurality of redemption identifiers and a request to redeem the plurality of redemption identifiers; and
an authorization module configured to issue a first authorization result to the requester in response to the request.

28. A method of enabling a customer to redeem a plurality of identifiers for at least one product, the method comprising:
establishing a database having stored therein the plurality of identifiers associated with the at least one product, the plurality of identifiers being collectively but not individually redeemable for the at least one product, the plurality of identifiers being redeemable upon receiving each of the plurality of identifiers in any successive order;
distributing a representation of each of the plurality of identifiers, each representation comprising information sufficient to identify only one of the plurality of identifiers, the act of distributing comprising providing a first identifier with a product sold to a customer at one time and distributing a second identifier through a different channel of distribution at a different time;
receiving from a requester a plurality of redemption identifiers;
receiving from the requestor a request to redeem the plurality of redemption identifiers for the at least one product;
comparing the plurality of redemption identifiers with the plurality of identifiers; and
responsive to a determination that the plurality of redemption identifiers match the plurality of identifiers, authorizing redemption for the at least one product;
issuing a first authorization result to the requester;
distributing the at least one product to at least one of the requestor and a recipient designated by the requester; and
amending the database based on the distributing action.
